(19) United States
(12) Patent Application Publication
(10) Pub. No.: US 2025/0318503 A1
(43) Pub. Date: Oct. 16, 2025

(54) PET WATER DISPENSER

(71) Applicant: Dongguan ZhiYiHong Hardware & Plastic Co., Ltd., Dongguan (CN)

(72) Inventor: Zhiqi Xue, Dongguan (CN)

(73) Assignee: Dongguan ZhiYiHong Hardware & Plastic Co., Ltd., Dongguan (CN)

(21) Appl. No.: 19/017,792

(22) Filed: Jan. 13, 2025

Related U.S. Application Data
(63) Continuation-in-part of application No. 18/764,328, filed on Jul. 4, 2024.

(30) Foreign Application Priority Data
Apr. 12, 2024 (CN) 202420758564.0

(51) Int. Cl. A01K 7/02

(52) U.S. Cl. CPC A01K 7/025

(57) ABSTRACT

A pet water dispenser includes a water tank for storing liquid, an upper cover installed above water tank and having a sink and a water leakage opening communicating with water tank in surface, a water pump extending into or onto upper cover from lower part of water tank and having a water supply opening in surface above upper cover; water pump includes a first accommodating chamber internally having a motor which drives pump blades below first accommodating chamber to rotate through a rotating shaft, second accommodating chambers of which walls define a pump chamber with downwards-extended wall of first accommodating chamber; a centrifugal water pump formed by pump blades in pump chamber and matched motor and including a water inlet communicating with water tank, and a water discharging opening; a water supply channel formed by second accommodating chambers sequentially communicating with water discharging opening and water supply opening.

### FIELD OF THE INVENTION

The present invention belongs to the technical field of pet supplies, and relates to a pet water dispenser.

### BACKGROUND OF THE INVENTION

Pet water dispensers on the market are widely used for providing flowing clean water for pets. However, most of existing products have major shortcomings in pump design, noise control, and cleaning, and cannot well meet the needs of users and pets, specifically,

existing pet water dispensers are generally equipped with diaphragm type negative pressure water pumps or adopt similar technologies to perform water supply. However, because the diaphragm type negative pressure water pumps pump water by repeated deformation of diaphragms, the mechanical structures are easily damaged due to long-term fatigue, resulting in the limited service life of the whole machine.

The negative pressure water pumps in work will produce obvious vibration and noise, especially at night or in a quiet environment, which easily disturbs users and pets.

### SUMMARY OF THE INVENTION

An objective of the present invention is to provide a pet water dispenser to overcome the defects in related technology, and the pet water dispenser can reduce the noise in use.

In order to achieve above objective, the present invention adopts the following technical solutions:
a pet water dispenser includes:
a water tank for storing liquid;
an upper cover installed above the water tank, in which, a surface of the upper cover is provided with a sink and a water leakage opening communicating with the water tank; and
a water pump which extends into or onto the upper cover from a lower part of the water tank and has a water supply opening in a surface above the upper cover;
the water pump internally includes:
a first accommodating chamber in which a motor is arranged, the motor driving pump blades below the first accommodating chamber to rotate through a rotating shaft;
second accommodating chambers of which walls define a pump chamber with a downwards-extended wall of the first accommodating chamber;
a centrifugal water pump which is formed by pump blades in the pump chamber and matched motor and includes a water inlet communicating with the water tank, and a water discharging opening; and
a water supply channel which is formed by the second accommodating chambers communicating with the water discharging opening of the centrifugal water pump and further communicating with the water supply opening.

Further, the water pump includes a pump core and a pump shell, and the first accommodating chamber is arranged in the pump core;
the pump shell is detachably connected to the pump core, and the pump shell sleeves the pump core; and
when the pump shell sleeves the pump core, gaps between the pump shell and the pump core form the second accommodating chambers.

Further, water outlets can be formed in the pump shell or the pump core.

Further, the pump shell includes a water inlet filter screen; and
the water inlet filter screen is arranged at a bottom part of the pump shell and covers the water inlet of the centrifugal water pump.

Further, a filter box is arranged below the water leakage opening of the upper cover; and
a circulating filter screen is arranged in the filter box and used for filtering liquid flowing from the water leakage opening.

Further, edges of the water outlets of the filter box are in close contact with an inner wall of the water tank; and
the close contact is performed to guide water to flow along the inner wall of the water tank so as to reduce noise.

Further, the filter box is clamped below the water leakage opening through an elastic hook.

Further, the upper cover is provided with an installation hole for the water pump to pass through, and the surface of the water pump is provided with a limiting protruding edge; and
the limiting protruding edge is matched with the edge of the installation hole, and the water pump is fixedly installed above the water tank in a clamped mode.

Further, the motor drives the pump blades through the rotating shaft, the rotating shaft is sleeved with a sealing piece, and the sealing piece is matched with the inner wall structure of the first accommodating chamber to realize sealing.

Further, the motor is a brushless motor, and a rotor of the brushless motor is connected to the pump blades so as to drive the pump blades to rotate.

Further, the water pump includes a power source and a control system, the power source is connected to the control system, the control system includes a control mainboard and an operation panel, the operation panel is connected to the control mainboard, and the control mainboard is connected to the motor.

According to the technical solution in the present invention, the centrifugal water pump pumps water through the centrifugal force produced by the rotating of the pump blades, which does not rely on repeated deformation of a diaphragm, so that the problem of mechanical damage caused by fatigue of the diaphragm is avoided; and the centrifugal water pump is stable in operation and smaller in vibration, the vibration and noise produced by the centrifugal water pump are remarkably reduced compared with those produced by a traditional diaphragm type negative pressure pump, so it is more suitably used at night or in a quiet environment. The edges of the water outlets of the filter box make close contact with the inner wall of the water tank to guide water to flow along the inner wall, thus the impact noise produced by the water freely falling is eliminated, and moreover, overall operation noise is further reduced, and a quieter use experience is provided for the users and pets. The pump core of the water pump is detachably connected to the pump shell, the pump shell can be rapidly detached from the pump core, and the water supply channel of the water pump is easy to clean, so that the maintenance convenience is greatly improved.

Other features and advantages of the present invention will be set forth in the subsequent description and, in part, become apparent from the description or become known by the implementation of the present invention. The objective and other advantages of the present invention may be realized and obtained by means of structures specifically indicated in the description and in the accompanying drawings.

### BRIEF DESCRIPTION OF THE DRAWINGS

The present invention will be described in detail below in conjunction with the accompanying drawings, so as to make the above-mentioned advantages of the present invention more clear.

FIG. 1 is a schematic diagram of an Embodiment 1 of a pet water dispenser according to the present invention;

FIG. 2 is a sectional diagram of a water pump in an Embodiment 1 of a pet water dispenser according to the present invention;

FIG. 3 is a schematic diagram of a pump core in an Embodiment 1 of a pet water dispenser according to the present invention;

FIG. 4 is a schematic diagram of a water pump in an Embodiment 1 of a pet water dispenser according to the present invention;

FIG. 5 is an exploded schematic diagram of a water pump in an Embodiment 1 of a pet water dispenser according to the present invention;

FIG. 6 is an exploded schematic diagram of an Embodiment 2 of a pet water dispenser according to the present invention;

FIG. 7 is a sectional schematic diagram of an Embodiment 2 of a pet water dispenser according to the present invention;

FIG. 8 is a schematic diagram of a water pump in an Embodiment 2 of a pet water dispenser according to the present invention;

FIG. 9 is a sectional diagram of an Embodiment 1 of a pet water dispenser according to the present invention;

FIG. 10 is a schematic diagram of a filter box in an Embodiment 1 of a pet water dispenser according to the present invention;

FIG. 11 is a schematic embodiment of installation of a water pump in an Embodiment 1 of a pet water dispenser according to the present invention;

FIG. 12 is a sectional schematic diagram of an Embodiment 3 of a pet water dispenser according to the present invention; and

FIG. 13 is a schematic diagram of assembling of a brushless motor in an Embodiment 3 of a pet water dispenser according to the present invention.

### DETAILED DESCRIPTION OF SOME EMBODIMENTS

The embodiments of the present invention are described in detail below, and examples of the embodiments are shown in the accompanying drawings, in which, the same or similar designations from beginning to end indicate the same or similar elements or elements having the same or similar functions. The embodiments described below with reference to the accompanying drawings are illustrative and are intended to be used in the interpretation of the present invention and should not be construed as limiting the present invention.

In the description of the present invention, it is to be understood that the terms “length”, “width”, “upper”, “lower”, “front”, “rear”, “left”, “right”, “vertical”, “horizontal”, “top”, “bottom”, “inner”, “outer”, etc., indicate the orientation or positional relationship based on the orientation or positional relationship described in the accompanying drawings, and are only for the convenience of description of the present invention and for simplifying the description, and not to indicate or imply that the device or element referred to must have a particular orientation, be constructed and operated in a particular orientation, Therefore, it cannot be construed as a limitation on the present invention.

In addition, the terms “first” and “second” are used for descriptive purposes only and should not be construed as indicating or implying relative importance or implying the number of technical features indicated. Thus, defining the “first” and “second” features may explicitly or implicitly include one or more of these features. In the description of the present invention, “plurality” means two or more of them, unless otherwise expressly and specifically qualified.

In the embodiments of the present invention, unless otherwise expressly specified and limited, the terms “installed”, “linked”, “connected”, “fixed” and other terms shall be understood broadly, for example, they may be fixedly connected, detachably connected, or integrally connected; or mechanically connected or electrically connected; or directly linked or indirectly linked through an intermediate medium, or internal communication of two elements or an interaction relationship between two elements. For those of ordinary skill in the art, the specific meaning of the above terms in the present invention may be understood according to the specific circumstances.

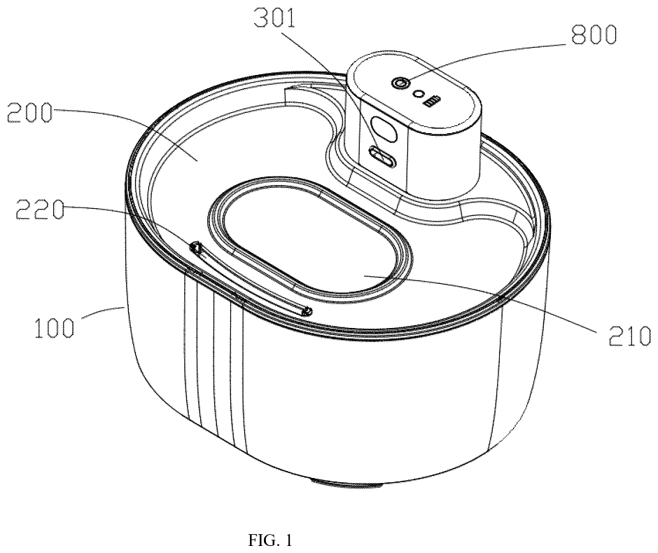

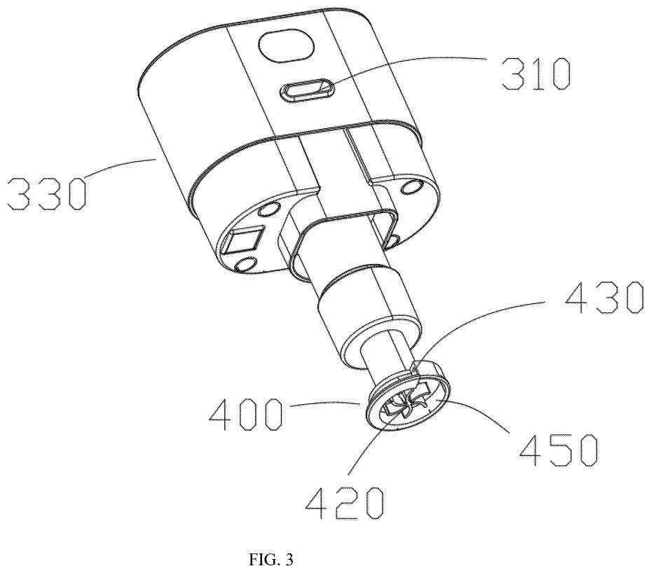

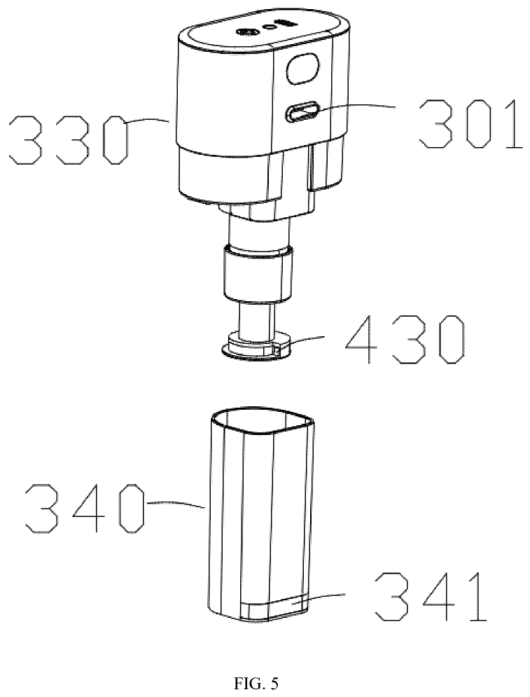

As shown in FIG. 1 to FIG. 5, according to the embodiment, a pet water dispenser includes the following main components:

Water tank 100: it is used for storing liquid, and is located at a bottom part of the whole water dispenser. The water tank 100 supplies the liquid for a water pump 300, and is connected to the water pump through a water inlet in a bottom part of the water tank.

Upper cover 200: it is installed above the water tank 100 and has a sink 210 and a water leakage opening 220 in a surface, and the sink 210 bears the liquid flowing out through a water supplying opening 301 for pets to directly drink; and the water leakage opening 220 is used for enabling redundant liquid in the sink to flow back to the water tank 100 to realize water circulation.

Water pump 300: it is installed between the water tank 100 and the upper cover 200, and is a core component for realizing the water circulation. The water pump 300 includes the following internal structures:

First accommodating chamber 310: it is used for accommodating a motor 410 that drives pump blades 420 below the first accommodating chamber to rotate. A lower wall of the first accommodating chamber 310 extends to form one part of a pump chamber 450 for limiting a working area of the pump blades 420.

Second accommodating chambers 320: walls of the second accommodating chambers 320 and the lower wall of the first accommodating chamber 310 define the pump chamber 450 for providing a liquid guide path for a centrifugal water pump. The second accommodating chambers 320 are further connected to the water supply opening 301 to form a complete water supply channel. Centrifugal water pump 400: it is formed by the pump blades 420 in the pump chamber 450 and the matched motor 410. The pump blades 420 are driven to rotate through the motor 410, the liquid in the water tank 100 is pumped in through a water inlet 440 with the centrifugal force and is discharged through a water discharging opening 430.

When the motor 410 is started, the pump blades 420 are driven to rotate at a high speed through a rotating shaft, and centrifugal force generated by the pump blade 420 will pump the liquid in the water tank 100 into the pump chamber 450 through the water inlet 440. The liquid in the pump chamber 450 is pressurized through the centrifugal force, and then is discharged into the second accommodating chambers 320 through the water discharging opening 430. The second accommodating chambers 320 receive the discharged liquid, and the liquid is guided to the water supply opening 301 through the water supply channel in the second accommodating chambers 320. The liquid flows into the sink 210 in the upper cover 200 through the water supply opening 301 for pets to directly drink. Redundant liquid flows back to the water tank 100 through the water leakage opening 220 in the upper cover 200 to realize water circulation.

The centrifugal water pump achieves stable pumping and pressurization of the liquid through high-speed rotation of the pump blades, and thus the problems of mechanical fatigue and unstable water supply of a traditional diaphragm type negative pressure pump are avoided. Through reasonable layout of the first accommodating chamber 310 and the second accommodating chambers 320, the working area of the pump chamber 450 is limited, the complete water supply channel is formed, and thus the internal structure of the water pump 300 is more compact. Through the optimal design of the pump chamber 450 of the centrifugal water pump, turbulent fluctuation and impact noise in the liquid flowing process are reduced, and a quieter environment is provided for users and the pets. The first accommodating chamber 310 is sealed according to the design, thus the liquid is prevented from entering the area with the motor 410, and long-term operation safety of the motor is guaranteed. Through the design in the embodiment, the pet water dispenser achieves stable water circulation and clean flowing water supply, and overcomes the defects of large noise, unstable water supply and the like in the related technology. The use convenience is improved through the compact structure and modular design, the maintenance cost is remarkably reduced, and the pet water dispenser is suitable for various family scenes and has wide market prospects.

In the embodiment, the water pump 300 includes a pump core 330 and a pump shell 340, and the first accommodating chamber 310 is formed in the pump core 330;
the pump shell 340 is detachably connected to the pump core 330, and the pump shell 340 sleeves the pump core 330; and
when the pump shell 340 sleeves the pump core 330, gaps between the pump shell 340 and the pump core 330 form the second accommodating chambers 320.

In the design of the traditional pet water dispenser, the internal structure of the water pump 300 is usually integral, so it is needed to disassemble the whole pump body for maintenance and cleaning, and consequently, the cleaning efficiency is low, and operation is complex. According to the embodiment, through modular design, the water pump 300 is divided into the pump core 330 and the pump shell 340, a detachable connection mode is adopted, the users can quickly separate the pump core 330 from the pump shell 340, and therefore an internal channel and related spare parts of the water pump 300 can be conveniently cleaned.

In addition, the gaps between the pump core 330 and the pump shell 340 are designed into the second accommodating chambers 320, so that the layout of the water flow channel can be optimized, the overall structure can be simplified, and the operation stability of device can be improved.

The pump core 330 is the core component of the water pump 300, and the first accommodating chamber 310 is formed in the pump core 330 and used for installing the motor 410. The rotating shaft of the motor 410 is connected to the pump blades 420, the pump blades 420 are located at the bottom part of the pump core 330 and are driven to rotate at a high speed through the rotation of the rotating shaft so as to generate centrifugal force, and therefore liquid pumping and discharging can be performed. An outer surface of the pump core 330 is precisely designed and connected to the pump shell 340 in a matched mode, and meanwhile the second accommodating chambers 320 are formed between the pump core 330 and the pump shell 340.

The pump shell 340 is of an external protection structure for the pump core 330 and wraps the pump core 330 in a sleeving mode. The water inlet 440 is formed in the bottom part of the pump shell 340 and used for guiding the liquid in the water tank 100 into the centrifugal water pump 400, and moreover, the internal structure of the pump shell 340 is precisely matched with the exterior of the pump core 330 to form the complete water flow channel of a pump body. The gaps between the pump shell 340 and the pump core 330 are designed into the second accommodating chambers 320 used for conveying the liquid discharged by the centrifugal water pump 400. The pump shell 340 and the pump core 330 are detachably connected, such as clamping, thus fixation is achieved, and the users can conveniently disassemble and assemble.

Through the modular design, the pump core 330 and the pump shell 340 can be rapidly disassembled, and the users can easily perform cleaning without complexly disassembling the whole pump body. After the water flow channel in the second accommodating chambers 320 is exposed, the users can directly clean, and accumulation of bacteria and incrustation is avoided.

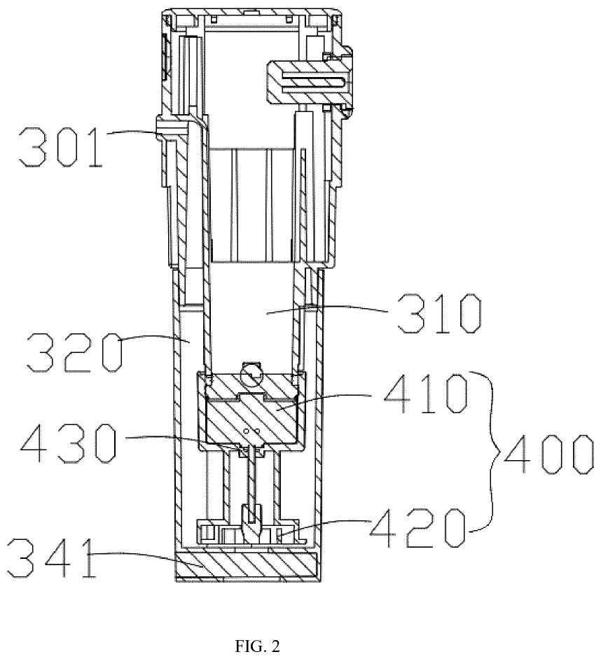

With reference to FIG. 2 to FIG. 5, in the embodiment, water outlets 520 are formed in the pump core 330. The water outlets 520 are formed in the top or the side of the pump core 330 and are in direction communication with the second accommodating chambers 320. After the liquid is discharged through the water discharging opening 430 in the centrifugal water pump 400, the liquid directly enters the second accommodating chambers 320 and is discharged through the water outlets 520.

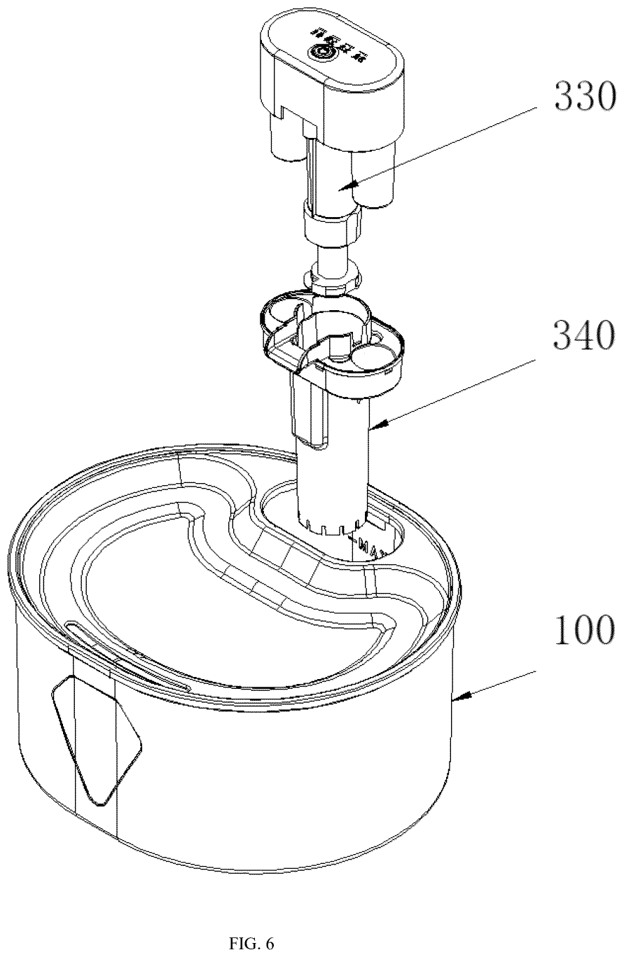

With reference to FIG. 6 to FIG. 8, in the Embodiment 2, the water outlets 520 are formed in the pump shell 340. The water outlets 520 are formed in the top of the pump shell 340 and connected to the water conveying channel in the pump shell 340, and after the liquid enters the pump shell 340 from the second accommodating chambers 320, the liquid flows upwards along the water conveying channel and is discharged through the water outlets 520 in the top.

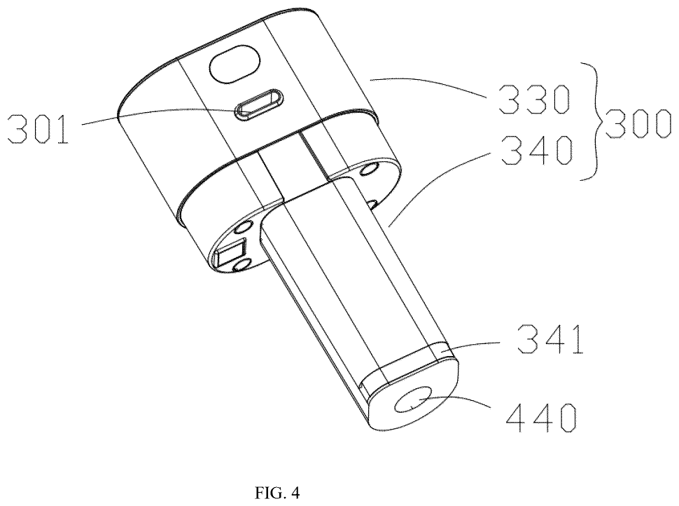

With reference to FIG. 4, in the embodiment, the pump shell 340 includes a water inlet filter screen 341; and
the water inlet filter screen 341 is arranged at the bottom part of the pump shell 340 and covers the water inlet 440 of the centrifugal water pump 400.

The water inlet 440 of the water pump 300 of the existing pet water dispenser is generally directly exposed in the water tank 100, so suspended particles, impurities and even pet hair in water may be pumped in by the water pump 300 in the running process, the impurities easily block the water pump 300 or wear spare parts such as pump blades 420 in the water pump 300, and as a result, normal running of the device is affected. In addition, the accumulated impurities may also lead to water quality deterioration of the water dispenser and thereby affecting the health of the pets. In order to solve the above problems, the water inlet filter screen 341 is arranged at the bottom of the pump shell 340 and covers the water inlet 440 in the centrifugal water pump 400, thus the suspended particles and the impurities in the water can be effectively filtered, the internal structure of the water pump 300 is protected, and overall water quality is improved.

The water inlet filter screen 341 is arranged at the bottom part of the pump shell 340, covers the whole water inlet 440 and is used for preliminarily filtering the liquid entering the water pump 300. The mesh size of the filter screen is precisely designed and is small enough to filter the suspended particles and the impurities in the water, as well as ensuring smooth water flowing and water pumping efficiency of the water pump 300. The filter screen is fixed at the bottom part of the pump shell 340 in a clamped or embedded manner, it is firmly installed and is conveniently disassembled and cleaned by the users.

When the water pump 300 works, the liquid in the water tank 100 enters the water pump 300 through the water inlet 440 at the bottom part of the pump shell 340. As the water inlet 440 is covered by the filter screen, all the liquid entering the water pump 300 is preliminarily filtered by the filter screen to remove the suspended particles, the hair and other impurities.

The filtered liquid enters the water inlet 440 of the centrifugal water pump 400, is pumped to the water discharging opening 430 of the water pump 300 through the pump blades 420, and is finally conveyed to the water supply opening 301 through the water supply channel for the pets to drink.

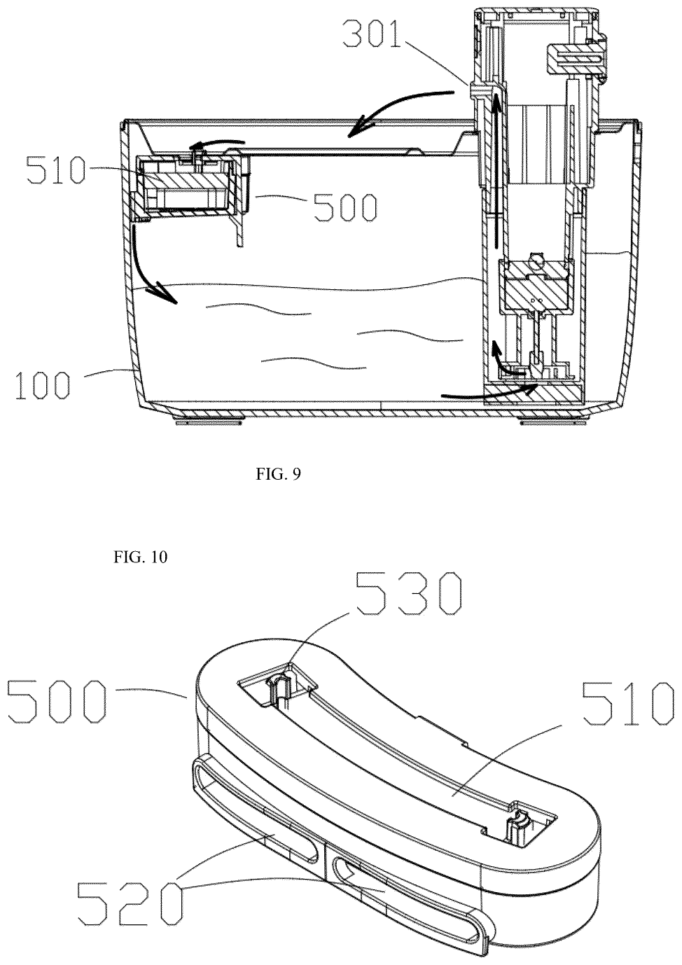

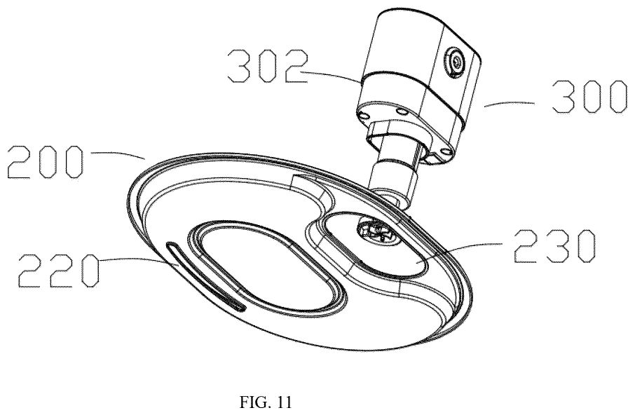

With reference to FIG. 9 to FIG. 10, in the embodiment, a filter box 500 is arranged below the water leakage opening 220 in the upper cover 200; and
a circulating filter screen 510 is arranged in the filter box 500 for filtering the liquid flowing from the water leakage opening 220. Most of existing pet water dispensers primarily filter the liquid only by simple filter devices, such as the water inlet filter screen 341 of the water pump 300, which cannot deeply filter the circularly flowing liquid, and in particular, after impurities are deposited or pet hairs are mixed in water, the water is easily subjected to secondary pollution to affect the health of the pets. In order to solve the above problems, in the embodiment, the filter box 500 is designed below the water leakage opening 220 of the upper cover 200, and the circulating filter screen 510 is arranged in the filter box 500. After the liquid flows into the water leakage opening 220 from the sink 210, the liquid is secondarily filtered by the circulating filter screen 510 in the filter box 500, so that residual impurities and suspended matters in the circulating process can be effectively removed, and the continuous cleanness of the water is guaranteed.

The filter box 500 is installed below the water leakage opening 220 in the upper cover 200, and is in direction communication with the water leakage opening 220. The filter box 500 is compact in structure, is tightly matched with the upper cover 200 in design and can be stably installed at the water leakage opening 220. The water outlets 520 are formed in the bottom part of the filter box 500 and are in communication with the interior of the water tank 100 to enable the filtered liquid to flow back into the water tank 100 so as to realize water circulation. The circulating filter screen 510 is installed inside the filter box 500 and used for further filtering the liquid flowing in through the water leakage opening 220. After flowing into the water leakage opening 220 from the sink 210 in the upper cover 200, the liquid enters the filter box 500 and flows through the circulating filter screen 510, and the filter screen captures the impurities and suspended matter in the liquid. The filtered liquid flows back into the water tank 100 through the water outlets 520 in the bottom part of the filter box 500, and therefore the circulating filtering process is completed. The circulating filter screen 510 can capture more impurities in the circulating process, and thus the impurities are effectively prevented from being deposited in the water tank 100 or entering the water pump 300.

In the embodiment, the edges of the water outlets 520 of the filter box 500 are in close contact with the inner wall of the water tank 100; and
the close contact is performed to guide water to flow along the inner wall of the water tank 100 so as to reduce noise.

In the water circulation process of the traditional pet water dispenser, when the liquid flows back to the water tank 100 from the filtering device or the sink 210, large noise will be produced by water falling freely or impacting the bottom part of the water tank 100. Particularly, at night or in a quiet environment, the noise may affect the comfort of the users and the pets.

In order to solve this problem, in the embodiment, structures in close contact with the inner wall of the water tank 100 are designed on the edges of the water outlets 520 of the filter box 500, which can guide the water to the surface of the inner wall of the water tank 100, thus the water can flow along the wall of the water tank 100 through the flow guiding effect of the inner wall, the impact noise produced by direct falling of the water is avoided, and the noise reduction effect is achieved.

The filter box 500 is arranged below the water leakage opening 220 of the upper cover 200 and used for filtering the liquid flowing from the sink 210, and the water outlets 520 in communication with the water tank 100 are formed in the bottom part of the filter box 500. The edges of the water outlets 520 of the filter box 500 are designed to be of a structure matched with the inner wall of the water tank 100, and thus close contact between the water outlets 520 and the inner wall of the water tank 100 is ensured. Due to the close contact design, the situation that the liquid directly falls into the bottom part of the water tank 100 through the water outlets 520 is avoided, and the noise produced by water impact is reduced from the source.

In the embodiment, the filter box 500 is clamped below the water leakage opening 220 through an elastic hook 530. Due to a clamping structure of the elastic hook 530, the filter box 500 can be simplified to be of a modular design that realizes rapid assembling and disassembling. Due to the structure of the elastic hook 530, stable installation of the filter box 500 is ensured, the users can rapidly take down, and the requirements for easy cleaning and easy maintenance are met.

The elastic hook 530 is designed on the periphery of the top of the filter box 500 and matched with the edge of the water leakage opening 220. The elastic hook 530 is made of high-elasticity plastic or other fatigue-resistant materials, has certain elastic deformation capacity and can achieve the clamping or separating effect during installing and dismounting. A hook claw structure of the elastic hook 530 is tightly engaged with the edge of the water leakage opening 220, thus the stability of the filter box 500 after installing is ensured, and separating caused by vibration or water impact in the running process is prevented.

The users only need to align the filter box 500 to an installation position below the water leakage opening 220 and slightly press the filter box upwards to clamp a hook claw of the elastic hook 530 to the edge of the water leakage opening 220, and the installation is completed. Due to the elastic design of the hook, moderate deformation is allowed, and clamping operation is effort-saving and ensures firmness.

When cleaning or maintaining, the users can slightly press or pull the elastic hook 530 to separate the elastic hook 530 from the edge of the water leakage opening 220, and then rapidly take down the filter box 500.

With reference to FIG. 11, in the embodiment, the upper cover 200 is provided with an installation hole 230 for the water pump 300 to pass through, and a limiting protruding edge 302 is arranged on the surface of the water pump 300.

The limiting protruding edge 302 is matched with the edge of the installation hole 230, and the water pump 300 is fixedly installed above the water tank 100 in a clamped manner.

The installation hole 230 is formed in the upper cover 200, the limiting protruding edge 302 is designed on the surface of the water pump 300, and the water pump 300 can be rapidly installed and stably fixed through clamping fit of the limiting protruding edge 302 and the edge of the installation hole 230. By means of this design, the firmness of the water pump 300 in the running process is ensured while the installation convenience is improved. During installation, the users align the protruding edge part of the water pump 300 with the installation hole 230 in the upper cover 200, and downwards apply force to insert the water pump 300 into the installation hole 230 until the limiting protruding edge 302 is completely clamped with the edge of the installation hole 230. After clamping is completed, the lower part of the limiting protruding edge 302 is attached to the edge of the installation hole 230, the water pump 300 is firmly fixed to the upper part of the upper cover 200, thus ensuring that the water pump 300 cannot loosen or fall off in the running process.

When cleaning or maintaining, the users can properly apply force to upwards pull the water pump 300 to separate the limiting protruding edge 302 from the edge of the installation hole 230, and therefore the water pump 300 can be rapidly disassembled, and operation is easy and convenient.

With reference to FIG. 2, in the embodiment, the motor 410 drives the pump blades 420 through the rotating shaft, the rotating shaft is sleeved with a sealing piece 430, and the sealing piece 430 is matched with the inner wall structure of the first accommodating chamber 310 to realize sealing. The sealing piece 430 is arranged and makes close contact with the inner wall of the first accommodating chamber 310, thus the contact between liquid and the area of the motor 410 can be effectively isolated, and the running safety of the motor 410 and the long-term reliability of device can be ensured.

The sealing piece 430 is arranged outside the rotating shaft of the motor 410, and forms a complete sealing barrier by structural matching with the inner wall of the first accommodating chamber 310. The sealing piece 430 completely wraps the periphery of the rotating shaft, thus the liquid can be prevented from entering the first accommodating chamber 310 from the pump chamber, and the motor 410 is protected against liquid damage. The sealing piece 430 is made of high-elasticity and corrosion-resistant materials such as silica gel, rubber or other high polymer materials, and has excellent sealing performance and fatigue resistance. The material design can adapt to long-term high-humidity environments, and prevent the sealing piece from losing efficacy under high loads.

When the device runs, the motor 410 drives the pump blades 420 to rotate at a high speed through the rotating shaft, the pump blades 420 generate the centrifugal force through which the function of pumping the liquid into the pump chamber through the water inlet 440 of the water tank 100 and discharging through the water discharging opening 430 is achieved. The sealing piece 430 outside the rotating shaft keeps a stable sealing effect all the time in the running process, and thus the liquid is effectively prevented from entering the first accommodating chamber 310.

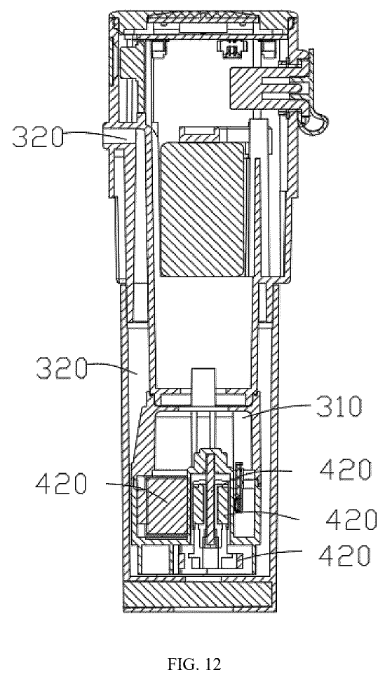

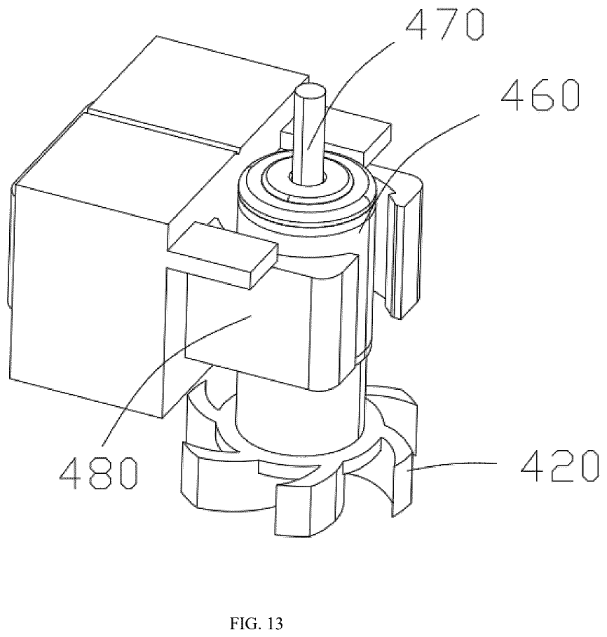

In the Embodiment 3 shown in FIG. 12 to FIG. 13, the motor is a brushless motor, and a rotor 460 of the brushless motor is connected to the pump blades 420 so as to drive the pump blades 420 to rotate. In traditional water pump design, the rotating shaft often needs to pass through the wall of the first accommodating chamber to be connected to the pump blades. It has a sealing difficulty in the design, the liquid possibly permeates into the motor area through the rotating shaft, thereby affecting the running reliability of the device.

In order to solve this the problem, in the embodiment, the brushless motor is adopted as a power core, the rotor 460 of the brushless motor is stably installed below the first accommodating chamber 310 through a central shaft 470, the structure that a traditional rotating shaft penetrates through the chamber wall is omitted, so that the hidden danger of liquid permeation is completely avoided.

The stator 480 of the brushless motor 410 is fixed in the first accommodating chamber 310, and the rotor 460 is installed below the first cavity through the central shaft 470 and is directly connected to the pump blades 420. The central shaft 470 is used for supporting the rotor 460 of the brushless motor, ensures that the rotor 460 runs stably and efficiently during the rotation process, and avoids the penetration of liquid into the first accommodating chamber at the same time.

After the brushless motor 410 is powered on, a stator 480 of the brushless motor generates a rotating magnetic field to drive the rotor 460 to rotate at a high speed through the central shaft 470. The rotor 460 drives the fixedly connected pump blades 420 to rotate synchronously, and thus a strong centrifugal force will be generated in the pump chamber. When the pump blades 420 rotate, the liquid in the water tank 100 will be pumped in through the water inlet 440. The liquid is pressurized through the centrifugal force, then enters the second accommodating chambers 320 through the water discharging opening 430 and is finally conveyed to the water supply opening 301.

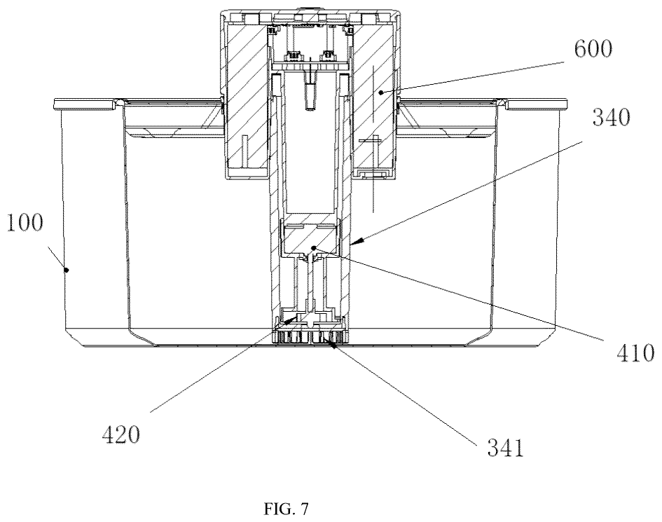

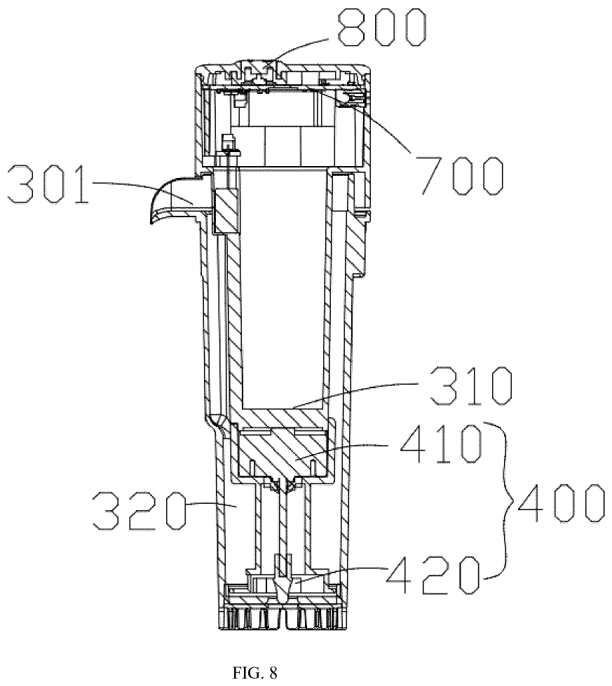

With reference to FIG. 7 to FIG. 8, in the embodiment, the water pump 300 includes a power source 600 and a control system, the power source 600 is connected to the control system, the control system includes a control mainboard 700 and an operation panel 800, the operation panel 800 is connected to the control mainboard 700, and the control mainboard 700 is connected to the motor 410.

The power source 600 module provides energy support for the operation of the whole control system and the water pump 300, thus ensuring stable power supply for the device in different working conditions.

The control mainboard 700 is the core of the whole control system and integrates a motor 410 driving circuit and a logic control unit. The control mainboard 700 is directly connected to the motor 410 through a circuit, and can accurately control the starting, stopping and operation speed of the motor 410 according to instructions of the users.

The operation panel 800 provides a human-computer interaction interface for the users, and the users can operate the device in a key or knob or touch mode.

Finally, it is to be noted that the above is only a preferred embodiment of the present invention and is not used for limiting the present invention, although the present invention is described in detail with reference to the foregoing embodiments, for those skilled in the art, it can still modify the technical solutions described in the foregoing embodiments, or replace some of the technical features in the same way. Any modification, equivalent replacement, improvement, etc., made within the spirit and principles of the present invention shall be included in the scope of protection of the present invention.

1. A pet water dispenser, comprising:
a water tank for storing liquid;
an upper cover installed above the water tank, wherein a surface of the upper cover is provided with a sink and a water leakage opening communicating with the water tank; and
a water pump which extends into or onto the upper cover from a lower part of the water tank and has a water supply opening in a surface above the upper cover;
the water pump internally comprises:
a first accommodating chamber in which a motor is arranged, the motor driving pump blades below the first accommodating chamber to rotate through a rotating shaft;
second accommodating chambers of which walls define a pump chamber with a downwards-extended wall of the first accommodating chamber;
a centrifugal water pump which is formed by pump blades in the pump chamber and matched motor and comprises a water inlet communicating with the water tank, and a water discharging opening; and
a water supply channel which is formed by the second accommodating chambers communicating with the water discharging opening of the centrifugal water pump and further communicating with the water supply opening.

2. The pet water dispenser according to claim 1, wherein the water pump comprises a pump core and a pump shell, and the first accommodating chamber is arranged in the pump core;
the pump shell is detachably connected to the pump core, and the pump shell sleeves the pump core; and
when the pump shell sleeves the pump core, gaps between the pump shell and the pump core form the second accommodating chambers.

3. The pet water dispenser according to claim 2, wherein water outlets can be formed in the pump shell or the pump core.

4. The pet water dispenser according to claim 2, wherein the pump shell comprises a water inlet filter screen; and
the water inlet filter screen is arranged at a bottom part of the pump shell and covers the water inlet of the centrifugal water pump.

5. The pet water dispenser according to claim 1, wherein a filter box is arranged below the water leakage opening of the upper cover; and
a circulating filter screen is arranged in the filter box and used for filtering liquid flowing from the water leakage opening.

6. The pet water dispenser according to claim 5, wherein edges of the water outlets in the filter box are in close contact with an inner wall of the water tank; and
the close contact is performed to guide water to flow along the inner wall of the water tank so as to reduce noise.

7. The pet water dispenser according to claim 5, wherein the filter box is clamped below the water leakage opening through an elastic hook.

8. The pet water dispenser according to claim 1, wherein the upper cover is provided with an installation hole for the water pump to pass through, and the surface of the water pump is provided with a limiting protruding edge; and
the limiting protruding edge is matched with the edge of the installation hole, and the water pump is fixedly installed above the water tank in a clamped mode.

9. The pet water dispenser according to claim 1, wherein the motor drives the pump blades through the rotating shaft, the rotating shaft is sleeved with a sealing piece, and the sealing piece is matched with the inner wall structure of the first accommodating chamber to realize sealing.

10. The pet water dispenser according to claim 1, wherein the motor is a brushless motor, and a rotor of the brushless motor is connected to the pump blades so as to drive the pump blades to rotate.

11. The pet water dispenser according to claim 1, wherein the water pump comprises a power source and a control system, the power source is connected to the control system, the control system comprises a control mainboard and an operation panel, the operation panel is connected to the control mainboard, and the control mainboard is connected to the motor.
